(19) United States
(12) Patent Application Publication
(10) Pub. No.: US 2022/0149683 A1
(43) Pub. Date: May 12, 2022

(54) ROTARY MOTOR AND MANUFACTURING METHOD FOR ROTOR

(71) Applicant: SEIKO EPSON CORPORATION, Tokyo (JP)

(72) Inventors: Hiroshi KOEDA, SUWA-SHI (JP); Kuniaki TANAKA, MATSUMOTO-SHI (JP); Shigekazu TAKAGI, SHIOJIRI-SHI (JP); Hiroshi WADA, AZUMINO-SHI (JP); Michio SATO, OKAYA-SHI (JP); Hideaki NISHIDA, SUWA-SHI (JP); Makoto MURAKAMI, SHIOJIRI-SHI (JP)

(21) Appl. No.: 17/512,699

(22) Filed: Oct. 28, 2021

(30) Foreign Application Priority Data
Oct. 30, 2020 (JP) 2020-183108

(51) Int. Cl. H02K 1/2793; H02K 15/03; H02K 16/02; H02K 21/24

(52) U.S. Cl. CPC H02K 1/2793; H02K 15/03; H02K 1/2783; H02K 21/24; H02K 16/02

(57) ABSTRACT

A rotary motor includes a stator and a rotor configured to rotate around a rotation axis. The rotor includes a frame including a first surface facing the stator and a plurality of first recesses arrayed along a circumferential direction around the rotation axis and opened on the first surface, the frame being formed in an annular shape, main magnets disposed in the first recesses or among the first recesses, and sub-magnets disposed in the first recesses when the main magnets are disposed among the first recesses and disposed among the first recesses when the main magnets are disposed in the first recesses.

The present application is based on, and claims priority from JP Application Serial Number 2020-183108, filed Oct. 30, 2020, the disclosure of which is hereby incorporated by reference herein in its entirety.

### BACKGROUND

### 1. Technical Field

The present disclosure relates to a rotary motor and a manufacturing method for a rotor.

### 2. Related Art

JP-A-2004-72820 (Patent Literature 1) discloses a rotor including a rotor core and permanent magnets annularly fixed along the outer circumferential surface of the rotor core. Patent Literature 1 discloses an AC motor including the rotor and a stator. The permanent magnets included in the rotor are formed in an array called Halbach magnet array. In the Halbach magnet array, a permanent magnet of one pole is divided into a plurality of permanent magnets. Magnetization directions of the divided permanent magnets are changed little by little, whereby high magnetic flux density can be obtained.

In the rotor disclosed in Patent Literature 1, a plurality of permanent magnets are disposed on a side surface of the rotor core formed in a columnar shape. As explained above, in the Halbach magnet array, the permanent magnet of one pole is divided into a plurality of permanent magnets. Accordingly, work for disposing a large number of permanent magnets at high density and bonding the large number of permanent magnets to the side surface of the rotor core is necessary.

However, the permanent magnets inevitably have slight dimension errors. If the permanent magnets having such dimension errors are disposed side by side along the circumferential direction of the rotor, the dimension errors accumulate in the circumferential direction. As a result, a magnetic characteristic of the rotor is deteriorated from a design value by positional deviation of the permanent magnets in the circumferential direction.

### SUMMARY

A rotary motor according to an application example of the present disclosure includes: a stator; and a rotor configured to rotate around a rotation axis. The rotor includes: a frame including a first surface facing the stator and a plurality of first recesses arrayed along a circumferential direction around the rotation axis and opened on the first surface, the frame being formed in an annular shape; main magnets disposed in the first recesses or among the first recesses; and sub-magnets disposed in the first recesses when the main magnets are disposed among the first recesses and disposed among the first recesses when the main magnets are disposed in the first recesses.

A manufacturing method for a rotor according to an application example of the present disclosure includes: preparing a frame including a first surface and a plurality of first recesses arrayed in a circumferential direction around the rotation axis and opened on the first surface, the frame being formed in an annular shape, unmagnetized first magnets, and unmagnetized second magnets; disposing the first magnets in the first recesses; disposing the second magnets among the first recesses; applying a magnetic field to one of the first magnets and the second magnets in a longitudinal direction crossing the first surface and magnetizing the one of the first magnets and the second magnets; and applying a magnetic field to another of the first magnets and the second magnets in a lateral direction different from the longitudinal direction and magnetizing the other of the first magnets and the second magnets.

### BRIEF DESCRIPTION OF THE DRAWINGS

FIG. 1 is a longitudinal sectional view showing a schematic configuration of an axial gap motor, which is a rotary motor according to a first embodiment.

FIG. 2 is a partial sectional view of a rotor shown in FIG. 1 taken along a surface orthogonal to the radial direction of the rotor.

FIG. 3 is a perspective view showing only a frame shown in FIG. 1.

FIG. 4 is a perspective view showing a configuration in which auxiliary pole magnets (sub-magnets) are added to the frame shown in FIG. 3.

FIG. 5 is a perspective view showing a configuration in which main magnetic pole magnets (main magnets) are added to the frame shown in FIG. 4.

FIG. 6 is a diagram showing lines of magnetic force formed around the main magnetic pole magnets and the auxiliary pole magnets.

FIG. 7 is a partial sectional view of a modification of the rotor shown in FIG. 2 taken along a surface orthogonal to the radial direction of the rotor.

FIG. 8 is a partial sectional view a rotor included in an axial gap motor, which is a rotary motor according to a second embodiment, taken along a surface orthogonal to the radial direction of the rotor.

FIG. 9 is a perspective view showing a first modification of a partition wall section included in the rotor shown in FIG. 8.

FIG. 10 is a sectional view showing a second modification of the partition wall section included in the rotor shown in FIG. 8 and main magnetic pole magnets engaging with through-holes.

FIG. 11 is a perspective view showing the main magnetic pole magnets engaging with the partition wall section shown in FIG. 10.

FIG. 12 is a perspective view showing only a shaft and a frame of a rotor included in a radial gap motor, which is a rotary motor according to a third embodiment.

FIG. 13 is a perspective view showing a configuration in which auxiliary pole magnets (sub-magnets) are added to the frame shown in FIG. 12.

FIG. 14 is a perspective view showing a configuration in which main magnetic pole magnets (main magnets) are added to the configuration shown in FIG. 13.

FIG. 15 is a flowchart for explaining a manufacturing method for a rotor according to a fourth embodiment.

FIG. 16 is a sectional view for explaining a manufacturing method for the rotor shown in FIG. 2.

FIG. 17 is a sectional view for explaining the manufacturing method for the rotor shown in FIG. 2.

FIG. 18 is a sectional view for explaining the manufacturing method for the rotor shown in FIG. 2.

### DESCRIPTION OF EXEMPLARY EMBODIMENTS

A rotary motor and a manufacturing method for a rotor according to the present disclosure are explained in detail below with reference to embodiments shown in the accompanying drawings.

### 1. First Embodiment

First, a rotary motor according to a first embodiment is explained.

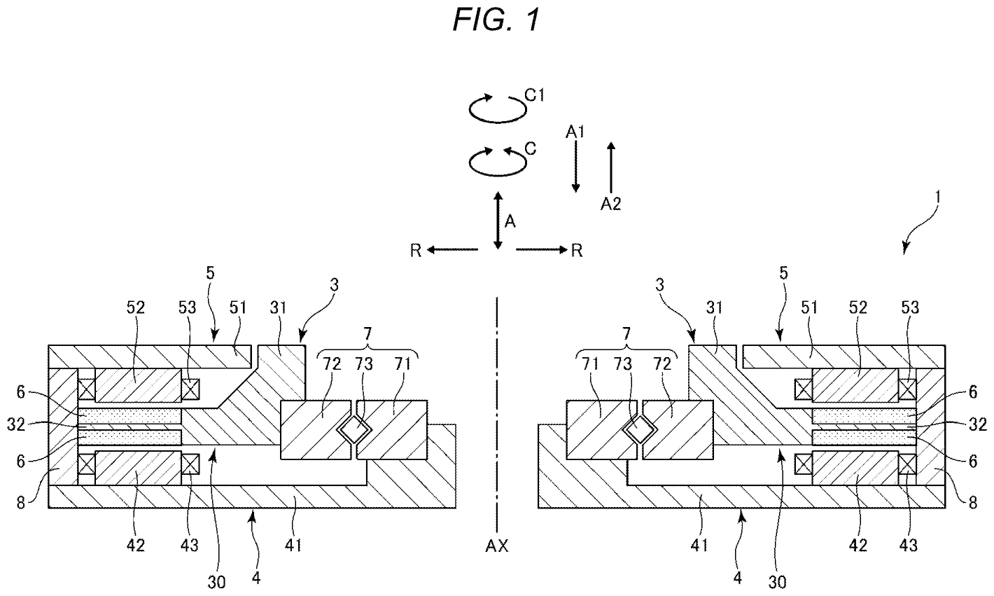

FIG. 1 is a longitudinal sectional view showing a schematic configuration of an axial gap motor, which is the rotary motor according to the first embodiment.

An axial gap motor 1 shown in FIG. 1 is a motor adopting a double stator structure. Specifically, the axial gap motor 1 shown in FIG. 1 includes a rotor 3 formed in an annular shape that rotates around a rotation axis AX and a pair of stators 4 and 5 disposed on both sides of the rotor 3 along the rotation axis AX. In the following explanation, a direction along the rotation axis AX is referred to as “axial direction A”, the circumferential direction of the rotor 3 is referred to as “circumferential direction C”, and the radial direction of the rotor 3 is referred to as “radial direction R”. In particular, a direction from the stator 5 to the stator 4 is referred to as “downward direction A1”, a direction from the stator 4 to the stator 5 is referred to as “upward direction A2”, and a clockwise direction at the time when the upward direction A2 is viewed from the downward direction A1 is referred to as “first circumferential direction Cl”.

The rotor 3 shown in FIG. 1 includes a frame 30 and permanent magnets 6 supported by the frame 30. The rotor 3 is explained in detail below.

As shown in FIG. 1, the stators 4 and 5 are disposed to sandwich the rotor 3 from both sides in the axial direction A. Specifically, the stator 4 is disposed in the downward direction A1 of the rotor 3 via a gap. The stator 5 is disposed in the upward direction A2 of the rotor 3 via a gap.

The stator 4 includes a bottom case 41 formed in an annular shape, a plurality of stator cores 42, and coils 43 disposed in the stator cores 42. The stator cores 42 are disposed in the upward direction A2 of the bottom case 41.

The stator 5 includes a top case 51 formed in an annular shape, a plurality of stator cores 52, and coils 53 disposed in the stator cores 52. The stator cores 52 are disposed in the downward direction A1 of the top case 51.

The configuration of the stators 4 and 5 is explained below. Since the stators 4 and 5 have the same configuration, the stator 4 is representatively explained below. Explanation about the stator 5 is omitted.

The bottom case 41 is configured by various magnetic materials such as a laminated body of electromagnetic steel plates and a green compact of magnetic powder, in particular, a soft magnetic material. The bottom case 41 may be configured by an aggregate of a plurality of parts.

As explained above, the stator 4 includes a plurality of stator cores 42. The stator cores 42 are disposed side by side at equal intervals along the circumferential direction C. The stator cores 42 are configured by various magnetic materials such as a laminated body of electromagnetic steel plates and a green compact of magnetic powder, in particular, a soft magnetic material.

The stator cores 42 may be fixed to the bottom case 41 by, for example, melting, an adhesive, or welding or may be engaged in the bottom case 41 using various engaging structures.

The coils 43 are wound on the outer circumferences of the stator cores 42. Electromagnets are configured by the stator cores 42 and the coils 43. The coils 43 may be lead wires wound on the stator cores 42. The lead wires may be wound in a bobbin shape in advance and fit in the outer circumferences of the stator cores 42.

The axial gap motor 1 includes a not-shown energization circuit. The coils 43 are coupled to the energization circuit. The coils 43 are energized at a predetermined cycle or in a predetermined pattern. For example, when a three-phase alternating current is applied to the coils 43, magnetic fluxes are generated from the electromagnets and magnetic forces act on the permanent magnets 6 opposed to the electromagnets. This state is periodically repeated, whereby the rotor 3 rotates around the rotation axis AX.

The stator 4 is explained above. The entire stator 4 may be molded by resin. By molding the stator 4 with the resin in this way, the bottom case 41 and the stator cores 42 can be fixed to each other. A more stable stator 4 can be obtained.

The stator 4 and the stator 5 are coupled via a center case 8. The center case 8 is located on the outer side of the rotor 3 and formed in a cylindrical shape.

The bottom case 41 and the frame 30 are coupled via a cross roller bearing 7. The cross roller bearing 7 includes an inner ring 71, an outer ring 72, and a roller 73. The bottom case 41 is coupled to the inner ring 71. The frame 30 is coupled to the outer ring 72. The inner ring 71 and the outer ring 72 rotate with respect to each other via the roller 73. Consequently, the rotor 3 is supported to be rotatable with respect to the stators 4 and 5. The cross roller bearing 7 may be replaced with a bearing of another type.

The configuration of the rotor 3 is explained.

As explained above, the rotor 3 shown in FIG. 1 includes the frame 30 and the permanent magnets 6.

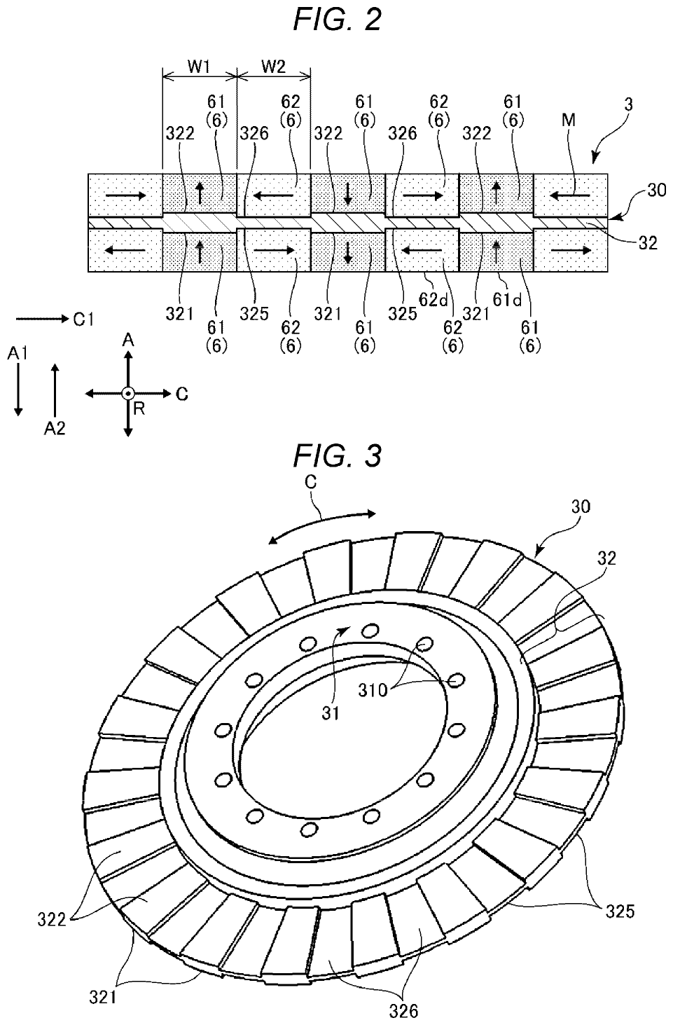

FIG. 2 is a partial sectional view of the rotor 3 shown in FIG. 1 taken along a surface orthogonal to the radial direction R. Arrows M shown in FIG. 2 represent directions of magnetic poles of the permanent magnets 6. FIG. 3 is a perspective view showing only the frame 30 shown in FIG. 1.

The frame 30 includes a hub 31 and a partition wall section 32 located on the outer side of the hub 31 and coupled to the hub 31 and is formed in an annular shape.

As shown in FIG. 1, the hub 31 is a part, the thickness of which along the rotation axis AX is larger than the thickness of the partition wall section 32. As shown in FIG. 3, the hub 31 includes a plurality of bolt holes 310 opened in the upward direction A2. By inserting not-shown bolts into the bolt holes 310, a not-shown output shaft can be coupled to the hub 31. By increasing the hub 31 in thickness, durability of the frame 30 against high torque can be improved.

As shown in FIG. 1, the partition wall section 32 is an annular part centering on the rotation axis AX. As shown in FIG. 2, the partition wall section 32 includes a first surface 321 facing the downward direction A1 and a second surface 322 facing the upward direction A2. As shown in FIGS. 2 and 3, the partition wall section 32 includes a plurality of first recesses 325 opened on the first surface 321 and a plurality of second recesses 326 opened on the second surface 322.

The first recesses 325 are disposed at equal intervals along the circumferential direction C. The first surface 321 sandwiched by the first recesses 325 is a part further projecting than the first recesses 325. Accordingly, in the partition wall section 32, the first recesses 325 and the first surface 321 sandwiched by the first recesses 325 are repeatedly disposed side by side along the circumferential direction C.

The second recesses 326 are disposed at equal intervals along the circumferential direction C. The second surface 322 sandwiched by the second recesses 326 is a part further projecting than the second recesses 326. Accordingly, in the partition wall section 32, the second recesses 326 and the second surface 322 sandwiched by the second recesses 326 are repeatedly disposed side by side along the circumferential direction C.

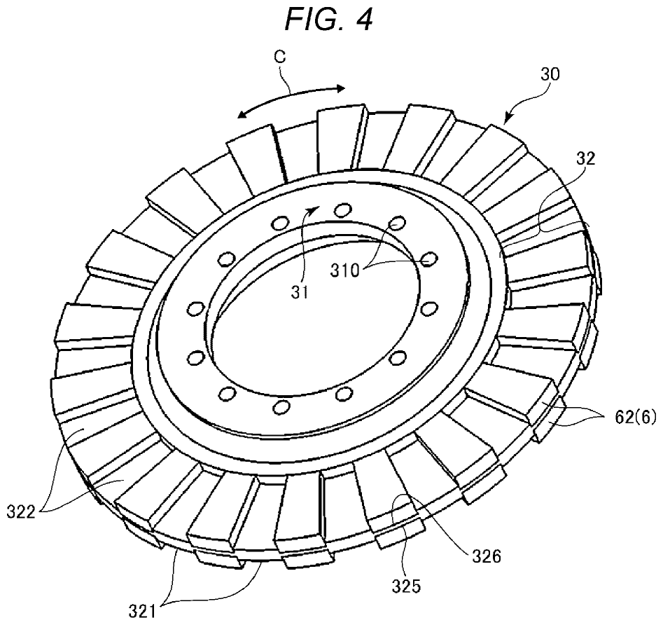

FIG. 4 is a perspective view showing a configuration in which auxiliary pole magnets 62 (sub-magnets) are added to the frame 30 shown in FIG. 3.

In this embodiment, the auxiliary pole magnets 62 are respectively disposed in the first recesses 325 and in the second recesses 326 of the frame 30. By disposing the auxiliary pole magnets 62 in the first recesses 325 and in the second recesses 326 in this way, it is possible to prevent dimension errors of the auxiliary pole magnets 62 and main magnetic pole magnets 61 from accumulating and improve position accuracy of the auxiliary pole magnets 62. The auxiliary pole magnets 62 are the permanent magnets 6, a magnetization direction of which is different from a magnetization direction of the main magnetic pole magnets 61 explained below. In this embodiment, the auxiliary pole magnets 62 are, in particular, the permanent magnets 6, magnetic poles of which are parallel to the circumferential direction C. The thickness of the auxiliary pole magnets 62 is sufficiently larger than the depth of the first recesses 325 and the second recesses 326. Accordingly, as shown in FIG. 4, the auxiliary pole magnets 62 disposed in the first recesses 325 and in the second recesses 326 are further projected than the first surface 321 and the second surface 322.

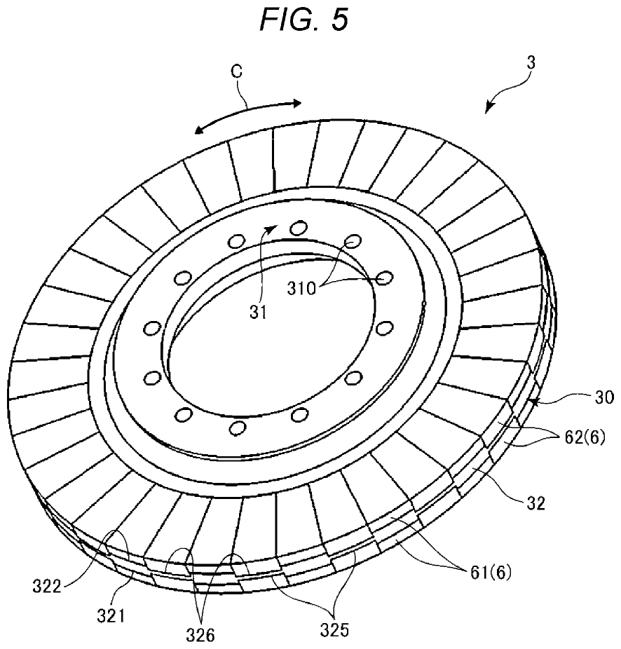

FIG. 5 is a perspective view showing a configuration in which the main magnetic pole magnets 61 (the main magnets) are added to the configuration shown in FIG. 4.

In this embodiment, the main magnetic pole magnets 61 are respectively disposed among the first recesses 325 and among the second recesses 326 of the frame 30. As explained above, the auxiliary pole magnets 62 disposed in the first recesses 325 and in the second recesses 326 project from the first surface 321 and the second surface 322. Accordingly, the main magnetic pole magnets 61 are disposed among the projecting auxiliary pole magnets 62. As a result, it is possible to prevent the dimension errors of the main magnetic pole magnets 61 and the auxiliary pole magnets 62 from accumulating and improve the position accuracy of the main magnetic pole magnets 61. Consequently, it is possible to prevent deterioration in a magnetic characteristic of the rotor 3 involved in positional deviation of the main magnetic pole magnets 61 and the auxiliary pole magnets 62, for example, fluctuation in magnetic flux density due to inconstant pitches among the main magnetic pole magnets 61 or inconstant pitches among the auxiliary pole magnets 62 and prevent occurrence of vibration and a torque decrease. The main magnetic pole magnets 61 are the permanent magnets 6, a magnetization direction of which is different from the magnetization direction of the auxiliary pole magnets 62 explained above. In this embodiment, the main magnetic pole magnets 61 are, in particular, the permanent magnets 6, magnetic poles of which are parallel to the axial direction A.

As explained above, by using the frame 30, the main magnetic pole magnets 61 and the auxiliary pole magnets 62 can be alternately disposed at target pitches along the circumferential direction C. As an example of a magnet array in which the main magnetic pole magnets 61 and the auxiliary pole magnets 62 are alternately disposed, there is an array called Halbach magnet array. The Halbach magnet array is explained below.

Among the permanent magnets 6 shown in FIG. 2, the permanent magnets 6 disposed further in the downward direction A1 than the partition wall section 32 include the auxiliary pole magnets 62 disposed in the first recesses 325 and the main magnetic pole magnets 61 disposed among the first recesses 325 (on the first surface 321). The direction of the magnetic poles of the permanent magnets 6 is set to rotate clockwise toward the first circumferential direction C1 shown in FIG. 2. The disposition of the permanent magnets 6 set such that the direction of the magnetic poles rotates in a fixed direction is called Halbach magnet array. Further in the downward direction A1 than the partition wall section 32, the direction of the magnetic poles is set to rotate clockwise toward the first circumferential direction C1. Therefore, it is possible to increase the intensity of a magnetic field formed further in the downward direction A1 than the rotor 3.

The permanent magnets 6 disposed in the upward direction A2 of the partition wall section 32 include the auxiliary pole magnets 62 disposed in the second recesses 326 and the main magnetic pole magnets 61 disposed among the second recesses 326 (on the second surface 322). The direction of the magnetic poles of the permanent magnets 6 is set to rotate counterclockwise toward the first circumferential direction C1 shown in FIG. 2, that is, such that the permanent magnets 6 are arrayed in the Halbach magnet array. In the upward direction A2 of the partition wall section 32, the direction of the magnetic poles is set to rotate counterclockwise toward the first circumferential direction C1. Therefore, it is possible to increase the intensity of a magnetic field formed further in the upward direction A2 than the rotor 3.

As explained above, in the axial gap motor 1 adopting the Halbach magnet array, the intensities of the magnetic fields formed further in both of the downward direction A1 and the upward direction A2 than the rotor 3 increase. Consequently, it is possible to generate a larger magnetic force between the rotor 3 and the stators 4 and 5. It is possible to achieve an increase in the torque of the axial gap motor 1.

In this embodiment, the positions of the first recesses 325 in the circumferential direction C and the positions of the second recesses 326 in the circumferential direction C are the same. That is, in FIG. 2, the first recesses 325 and the second recesses 326 are present in the same positions in the circumferential direction C. Consequently, it is possible to align the positions of the main magnetic pole magnets 61 in the circumferential direction C and the positions of the auxiliary pole magnets 62 in the circumferential direction C. As a result, in the downward direction A1 and the upward direction A2 of the partition wall section 32, the thicknesses of the main magnetic pole magnets 61 can be equalized and the thicknesses of the auxiliary pole magnets 62 can also be equalized. Therefore, the magnetic field intensities can also be equalized. Consequently, a magnetic force generated between the rotor 3 and the stator 4 and a magnetic force generated between the rotor 3 and the stator 5 can be equalized. As a result, vibration caused by a difference between the magnetic forces is suppressed. It is possible to realize the axial gap motor 1 excellent in rotation stability.

As shown in FIG. 2, when the width in the circumferential direction C of the main magnetic pole magnets 61 is represented as W1 and the width in the circumferential direction C of the auxiliary pole magnets 62 is represented as W2, the width W1 may be equal to or smaller than the width W2 or may be larger than the width W2. In particular, in the latter case, compared with the former case, it is possible to improve the intensity of a magnetic field formed around the rotor 3.

A ratio W1/W2 of the width W1 to the width W2 is not particularly limited. However, the ratio W1/W2 is preferably set to 1.1 or more and 5.0 or less and more preferably set to 1.5 or more and 3.0 or less. Consequently, it is possible to particularly increase the magnetic field intensity.

Examples of a constituent material of the frame 30 include metal materials such as stainless steel, an aluminum alloy, a magnesium alloy, and a titanium alloy, ceramic materials such as alumina and zirconia, resin materials such as engineering plastic, various fiber-reinforced plastics such as CFRP (Carbon Fiber Reinforced Plastics) and GFRP (Glass Fiber Reinforced Plastics), and fiber-reinforced composite materials such as FRC (Fiber Reinforced Ceramics) and FRM (Fiber Reinforced Metallics).

The constituent material of the frame 30 is preferably a nonmagnetic material. Consequently, the frame 30 is less easily affected by a magnetic flux and a problem such as a decrease in torque less easily occurs. The nonmagnetic material means a material, specific magnetic permeability of which is approximately 0.9 or more and 3.0 or less.

Further, the frame 30 preferably has insulation. Consequently, even if a magnetic flux passing through the frame 30 changes, an eddy current less easily occurs. As a result, it is possible to suppress deterioration in energy conversion efficiency involved in an eddy current loss in the axial gap motor 1. The insulation means that, for example, volume resistivity by a method specified in JIS K 6911:2006 is 10⁶ Ωcm or more.

Further, a ceramics material has small stretch and high rigidity. Accordingly, when the ceramics material is used as the constituent material of the frame 30, the frame 30 having small deformation can be realized. Since the deformation of the frame 30 is suppressed, even when torque periodically changes when the rotor 3 rotates, vibration less easily occurs in the rotor 3. Therefore, occurrence of noise involved in the vibration can also be suppressed.

Since the ceramic material has particularly low magnetic permeability, the ceramic material is useful as the constituent material of the frame 30 in that viewpoint.

The permanent magnets 6 are fixed to the partition wall section 32 using, for example, an adhesive, a fastening tool, or a tying tool. The adhesive and the other means may be concurrently used. Further, the permanent magnets 6 may be bonded by the adhesive. The adhesive or mold resin may be disposed to cover the permanent magnets 6.

When the adhesive is used, the first surface 321 and the second surface 322 and the insides of the first recesses 325 and the second recesses 326 may be respectively roughened. Consequently, it is possible to increase a bonding force by the adhesive based on an anchor effect.

As explained above, the axial gap motor 1 (the rotary motor) according to this embodiment includes the stators 4 and 5 and the rotor 3 that rotates around the rotation axis AX. The rotor 3 includes the frame 30, the main magnetic pole magnets 61 (the main magnets), and the auxiliary pole magnets 62 (the auxiliary magnets). The frame 30 includes the first surface 321 formed in an annular shape and facing the stator 4 and the plurality of first recesses 325 arrayed along the circumferential direction C around the rotation axis AX and opened on the first surface 321. The main magnetic pole magnets 61 are disposed among the first recesses 325. The auxiliary pole magnets 62 are disposed in the first recesses 325.

With such a configuration, by disposing the auxiliary pole magnets 62 in the first recesses 325, it is possible to prevent dimension errors of the auxiliary pole magnets 62 and the main magnetic pole magnets 61 from accumulating. Therefore, it is possible to improve position accuracy of the auxiliary pole magnets 62 with respect to the frame 30. Consequently, it is possible to prevent deterioration in a magnetic characteristic of the rotor 3 involved in positional deviation of the main magnetic pole magnets 61 and the auxiliary pole magnets 62.

Since positioning can be performed simply by disposing the auxiliary pole magnets 62 in the first recesses 325, assembly work of the rotor 3 can be easily performed.

Further, by disposing the auxiliary pole magnets 62 in the first recesses 325, a contact area of the first recesses 325 and the auxiliary pole magnets 62 can be increased. As a result, for example, when the auxiliary pole magnets 62 are bonded in the first recesses 325 using an adhesive, bonding strength can be increased.

In this embodiment, since the permanent magnets 6 can be fixed to the partition wall section 32, a member for fixing the permanent magnets 6 does not need to be disposed between the stators 4 and 5 and the permanent magnets 6. That is, voids can be formed between the permanent magnets 6 and the stators 4 and 5. As a result, it is possible to prevent a harmful effect due to disposition of some member, for example, a harmful effect of a decrease in torque by disposition of a member or occurrence of demagnetization of the permanent magnets 6 by an increase in magnetic resistance.

Influence of presence or absence of the first recesses 325 on magnetic field intensity around the rotor 3 is explained.

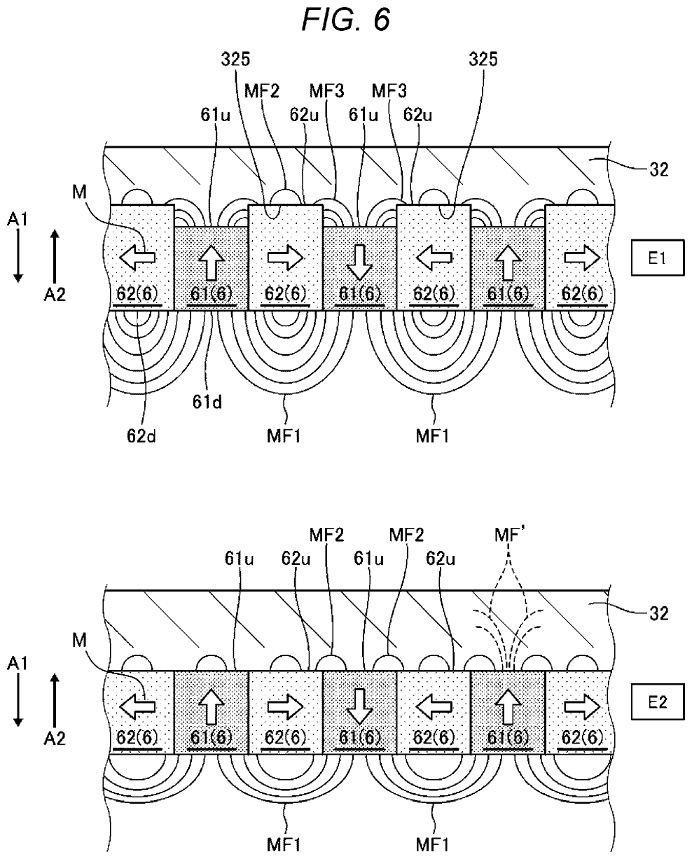

FIG. 6 is a diagram showing lines of magnetic force formed around the main magnetic pole magnets 61 and the auxiliary pole magnets 62. In FIG. 6, the densities of the lines of magnetic force are compared between when the frame 30 includes the first recesses 325, that is, an example E1 and when the frame 30 does not include the first recesses 325, that is, a comparative example E2.

In the comparative example E2, upper surfaces 61u on the partition wall section 32 side of the main magnetic pole magnets 61 and upper surfaces 62u on the partition wall section 32 side of the auxiliary pole magnets 62 are aligned. Accordingly, lines of magnetic force MF2 generated on the partition wall section 32 side (the upper side of FIG. 6) has low density. In the comparative example E2, since the upper surfaces 61u and the upper surfaces 62u are aligned, a line of magnetic force MF′ from the upper surface 61u of the main magnetic pole magnet 61 indicated by a broken line less easily occurs. Accordingly, in the comparative example E2, the density of lines of magnetic force MF1 generated on the opposite side of the partition wall section 32 side, that is, the stator 4 side (the lower side of FIG. 6) cannot be sufficiently increased.

In contrast, in the example E1, the upper surfaces 61u on the partition wall section 32 side of the main magnetic pole magnets 61 and the upper surfaces 62u on the partition wall section 32 side of the auxiliary pole magnets 62 are not aligned. Specifically, since the auxiliary pole magnets 62 are disposed in the first recesses 325, the upper surfaces 62u of the auxiliary pole magnets 62 are located further in the upward direction A2 than the upper surfaces 61u of the main magnetic pole magnets 61. By causing such a level difference, lines of magnetic force MF3 connecting the main magnetic pole magnets 61 and the auxiliary pole magnets 62 can be generated anew on the partition wall section 32 side. As a result, in the example E1, it is possible to increase the density of the lines of magnetic force MF1 generated on the stator 4 side. Therefore, in the example E1, it is possible to realize the axial gap motor 1 in which a further increase in torque is achieved.

The depth of the first recesses 325 and the depth of the second recesses 326 are not respectively particularly limited but are preferably 1% or more and 40% or less, more preferably 5% or more and 35% or less, and still more preferably 10% or more and 30% or less of the thickness of the partition wall section 32. Consequently, it is possible to secure mechanical strength of the frame 30 while sufficiently enjoying an effect of increasing the density of the lines of magnetic force MF1.

In the example E1 shown in FIG. 6, the thickness of the main magnetic pole magnets 61 is smaller than the thickness of the auxiliary pole magnets 62. Accordingly, in the example E1 shown in FIG. 6, lower surfaces 61d of the main magnetic pole magnets 61 and lower surfaces 62d of the auxiliary pole magnets 62 are the same surfaces without a level difference. Consequently, it is easier to bring both of the main magnetic pole magnets 61 and the auxiliary pole magnets 62 and the stator 4 close to each other. This contributes to a further increase in torque. However, this configuration is not essential. A level difference may be present between the lower surfaces 61d of the main magnetic pole magnets 61 and the lower surfaces 62d of the auxiliary pole magnets 62.

Since the rotary motor in this embodiment has the double stator structure as explained above, the frame 30 shown in FIG. 2 includes, in addition to the first surface 321 and the first recesses 325 provided in the downward direction A1 of the frame 30, the second surface 322 opposite to the first surface 321 provided in the upward direction A2 and the plurality of second recesses 326 arrayed along the circumferential direction C around the rotation axis AX and opened on the second surface 322. In FIG. 2, the positions of the first recesses 325 and the positions of the second recesses 326 in the circumferential direction C are the same.

With such a configuration, in the downward direction A1 and the upward direction A2 of the partition wall section 32, the thicknesses of the main magnetic pole magnets 61 can be equalized and the thicknesses of the auxiliary pole magnets 62 can be equalized. Therefore, magnetic field intensities can also be equalized. As a result, a magnetic force generated between the rotor 3 and the stator 4 and a magnetic force generated between the rotor 3 and the stator 5 can be equalized. It is possible to realize the axial gap motor 1 having satisfactory rotation stability in which occurrence of vibration due to a difference in a magnetic force is suppressed.

The axial gap motor 1 according to this embodiment has the double stator structure as explained above but may have a single stator structure. In this case, for example, the stator 5 only has to be omitted and, at the same time, the permanent magnets 6 disposed further on the upward direction A2 than the partition wall section 32 only have to be omitted.

Further, in this embodiment, as explained above, the main magnetic pole magnets 61 (the main magnets) are disposed among the first recesses 325 and the auxiliary pole magnets 62 (the sub-magnets) are disposed in the first recesses 325. Consequently, as shown in the example E1 in FIG. 6, the upper surfaces 62u of the auxiliary pole magnets 62 can be located further in the upward direction A2 than the upper surfaces 61u of the main magnetic pole magnets 61. As a result, the lines of magnetic force MF3 connecting the main magnetic pole magnets 61 and the auxiliary pole magnets 62 shown in the example E1 in FIG. 6 can be generated anew. The density of the lines of magnetic force MF1 generated on the stator 4 side of the rotor 3 can be increased.

In this embodiment, since the rotary motor has the double stator structure, the main magnetic pole magnets 61 are disposed among the second recesses 326 as well and the auxiliary pole magnets 62 are disposed in the second recesses 326 as well. Consequently, it is also possible to increase the density of lines of magnetic force generated on the stator 5 side of the rotor 3.

The rotary motor according to this embodiment is preferably, in particular, the axial gap motor 1. Since the length in the axial direction A of the axial gap motor 1 can be easily reduced, it is easy to form the axial gap motor 1 flat. Accordingly, by using the axial gap motor 1, it is possible to realize, for example, a motor for arm driving contributing to a reduction in the size and a reduction in the weight of a robot arm and an in-wheel motor for electric automobile reduced in size and weight. The axial gap motor 1 applied with the rotary motor according to this embodiment is flat but an increase in torque of the axial gap motor 1 is achieved. Therefore, the axial gap motor 1 is also applicable to a direct drive without using a speed reducer.

### 2. Modification

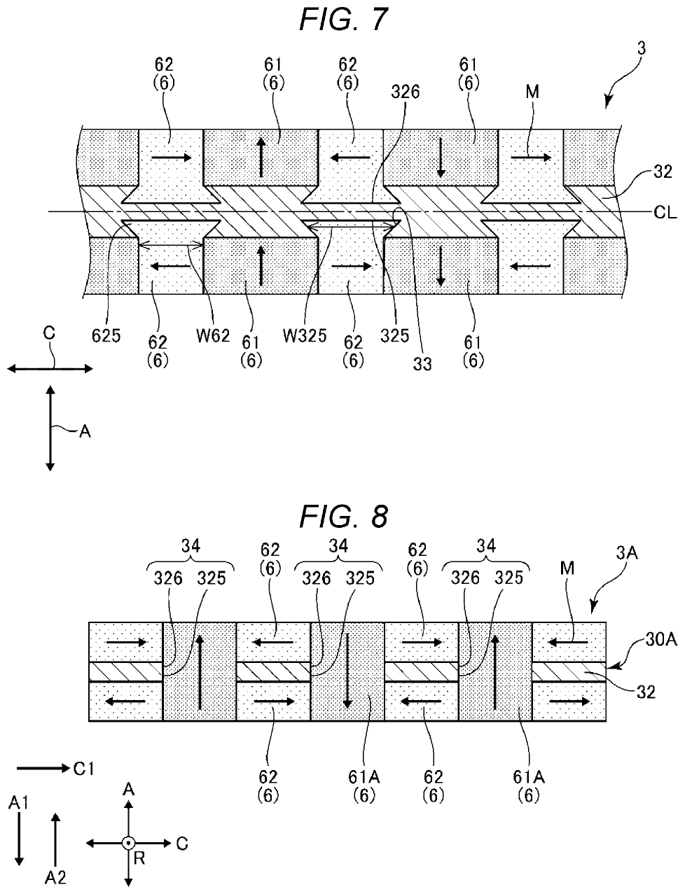

FIG. 7 is a partial sectional view of the rotor 3 shown in FIG. 2 taken along a surface orthogonal to the radial direction R.

A modification of the first embodiment is explained below. In the following explanation, differences from the first embodiment are mainly explained. Explanation about similarities to the first embodiment is omitted. In FIG. 7, the same components as the components in the first embodiment are denoted by the same reference numerals and signs.

The modification of the first embodiment is the same as the first embodiment except that the auxiliary pole magnet 62 (the sub-magnet) includes a sub-magnet engagement structure 625 that engages in the first recess 325. The sub-magnet engagement structure 625 shown in FIG. 7 is a structure in which width W62 in the circumferential direction C of a portion of the auxiliary pole magnet 62 fit in the first recess 325 changes to increase toward a center line CL of the partition wall section 32. The center line CL is a line connecting center points of the first recesses 325 and the second recesses 326 of the partition wall section 32 in FIG. 7.

On the other hand, width W325 in the circumferential direction C of the first recess 325 shown in FIG. 7 also increases toward the center line CL of the partition wall section 32. A structure in which the width W325 changes along the axial direction A in this way is a recess engagement structure 33. The first recess 325 shown in FIG. 7 includes such a recess engagement structure 33. The recess engagement structure 33 shown in FIG. 7 is a so-called dovetail groove.

When the auxiliary pole magnet 62 includes the sub-magnet engagement structure 625, for example, by forming the recess engagement structure 33 in the first recess 325 and engaging the sub-magnet engagement structure 625 and the recess engagement structure 33, it is possible to mechanically fix the first recess 325 and the auxiliary pole magnet 62. As a result, it is possible to more surely perform fixing and alignment of the auxiliary pole magnet 62 with respect to the first recess 325. In particular, in the structure shown in FIG. 7, since the auxiliary pole magnet 62 can be more firmly fixed in the axial direction A, it is possible to more surely prevent falling of the auxiliary pole magnet 62 involved in a magnetic force. Such mechanical fixing may be used concurrently with fixing by an adhesive.

In the modification explained above, the same effects as the effects in the first embodiment are obtained.

### 3. Second Embodiment

A rotary motor according to a second embodiment is explained.

FIG. 8 is a partial sectional view of a rotor 3A included in the axial gap motor 1, which is the rotary motor according to the second embodiment, taken along a surface orthogonal to the radial direction R.

The second embodiment is explained blow. In the following explanation, differences from the first embodiment are mainly explained. Explanation about similarities to the first embodiment is omitted. In FIG. 8, the same components as the components in the first embodiment are denoted by the same reference numerals and signs.

The second embodiment is the same as the first embodiment except that a frame 30A includes through-holes 34 obtained by connecting the first recesses 325 and the second recesses 326 along the rotation axes AX (the axial direction A). The through-holes 34 can be regarded as holes obtained by integrating the first recesses 325 and the second recesses 326. Therefore, the frame 30A according to this embodiment includes the first recesses 325 and the second recesses 326 connected to each other.

Since the frame 30A includes the through-holes 34, a reduction in the weight of the rotor 3A can be achieved.

In this embodiment, main magnetic pole magnets 61A (main magnets) are disposed in the through-holes 34 that can be regarded as the first recesses 325 and the second recesses 326. Further, the auxiliary pole magnets 62 (the sub-magnets) are respectively disposed among the first recesses 325 and among the second recesses 326.

Since the main magnetic pole magnets 61A are disposed in the through-holes 34, two main magnetic pole magnets 61 in the first embodiment can be integrated into one main magnetic pole magnet 61A. That is, the same function as the function of the two main magnetic pole magnets 61 in the first embodiment can be realized by the one main magnetic pole magnet 61A. Consequently, it is possible to achieve a reduction the number of components of the rotor 3A and reduce assembly manhour.

In the second embodiment explained above, the same effects as the effects of the first embodiment are obtained.

### 4. Modifications

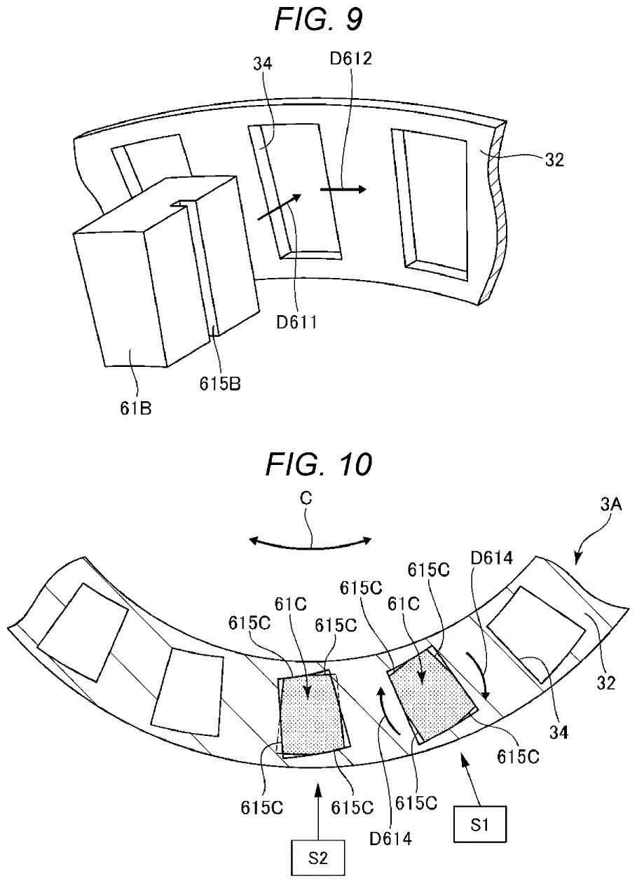

FIG. 9 is a perspective view showing a first modification of the partition wall section 32 included in the rotor 3A shown in FIG. 8.

A first modification of the second embodiment is explained below. In the following explanation, differences from the second embodiment are mainly explained. Explanation about similarities to the second embodiment is omitted. In FIG. 9, the same components as the components in the second embodiment are denoted by the same reference numerals and signs.

The first modification of the second embodiment is the same as the second embodiment except that a main magnetic pole magnet 61B (a main magnet) includes a main magnet engagement structure 615B that engages in the through-hole 34. The main magnet engagement structure 6158 shown in FIG. 9 is a groove provided in the main pole magnet 61B. The groove has width into which the partition wall section 32 surrounding the through-hole 34 can be inserted.

After the main magnetic pole magnet 61B is inserted into the through hole 34 along an inserting direction D611 shown in FIG. 9, the main magnetic pole magnet 61B is moved to be shifted along an engaging direction D612 shown in FIG. 9. Consequently, the partition wall section 32 surrounding the through-hole 34 can be fit (engaged) in the main magnet engagement structure 615B of the main magnetic pole magnet 61B. As a result, the through-hole 34 and the main magnetic pole magnet 61B can be mechanically fixed. It is possible to more surely perform fixing and alignment of the main magnetic pole magnet 61B with respect to the through-hole 34. Such mechanical fixing may be used concurrently with fixing by an adhesive.

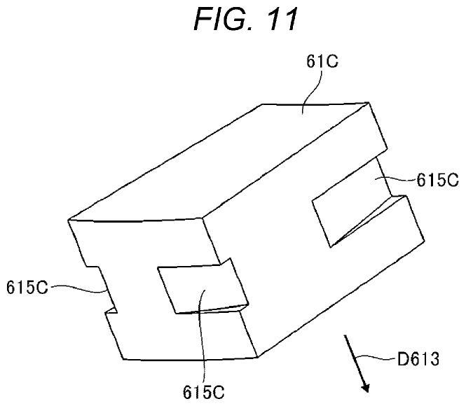

FIG. 10 is a sectional view showing a second modification of the partition wall section 32 included in the rotor 3A shown in FIG. 8 and main magnetic pole magnets 61C engaging with the through-holes 34. FIG. 11 is a perspective view showing the main magnetic pole magnets 61C engaging with the partition wall section 32 shown in FIG. 10. The sectional view of FIG. 10 is a sectional view of the partition wall section 32 taken along a center surface of the thickness of the partition wall section 32.

A second modification of the second embodiment is explained below. In the following explanation, differences from the second embodiment are mainly explained. Explanation about similarities to the second embodiment is omitted. In FIGS. 10 and 11, the same components as the components in the second embodiment are denoted by the same reference numerals and signs.

The second modification of the second embodiment is the same as the second embodiment except that the main magnetic pole magnets 61C (the main magnets) include main magnet engagement structures 615C that engage in the through-holes 34. The main magnet engagement structures 615C shown in FIG. 11 are grooves provided in the main magnetic pole magnet 61C. The grooves have width into which the partition wall section 32 surrounding the through-hole 34 can be inserted.

In FIG. 10, a state immediately after insertion S1 and an engaged state S2 are shown as two states in which the postures of the main magnetic pole magnet 61C with respect to the through-hole 34 are different. In the state immediately after insertion S1 is a state immediately after the main magnetic pole magnet 61C is inserted into the through-hole 34 along an inserting direction D613 shown in FIG. 11. The engaged state S2 is a state in which the main magnetic pole magnet 61C in the state immediately after insertion S1 is rotated and the partition wall section 32 surrounding the through-hole 34 is fit in the main magnet engagement structure 615C.

A shape of the through-hole 34 shown in FIG. 10 is a shape into which the main magnetic pole magnet 61C can be inserted when the main magnetic pole magnet 61C is in a posture indicated by the state immediately after insertion S1 in FIG. 11. When the main magnetic pole magnet 61C in the state immediately after insertion S1 is rotated in clockwise direction D614, the main magnetic pole magnet 61C shifts to the engaged state S2. In the engaged state S2, the partition wall section 32 surrounding the through-hole 34 is fit in the main magnet engagement structure 615C. Consequently, the through-hole 34 and the main magnetic pole magnet 61C can be mechanically fixed. It is possible to more surely perform fixing and alignment of the main magnetic pole magnet 61C with respect to the through-hole 34. Such mechanical fixing may be used concurrently with fixing by an adhesive.

In the modification explained above, the same effects as the effects in the second embodiment are obtained.

### 5. Third Embodiment

A rotary motor according to a third embodiment is explained.

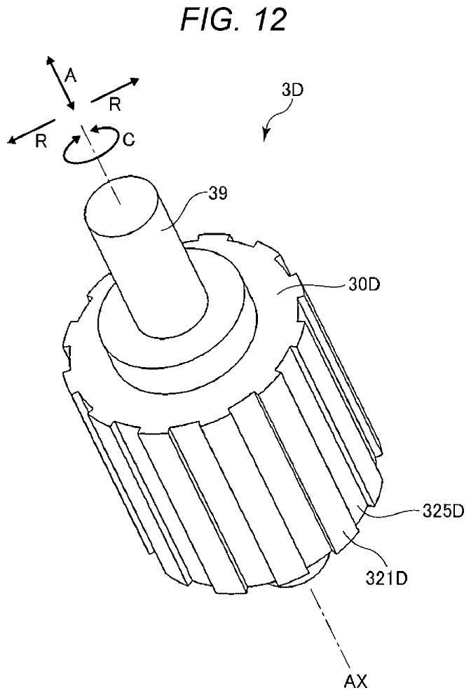

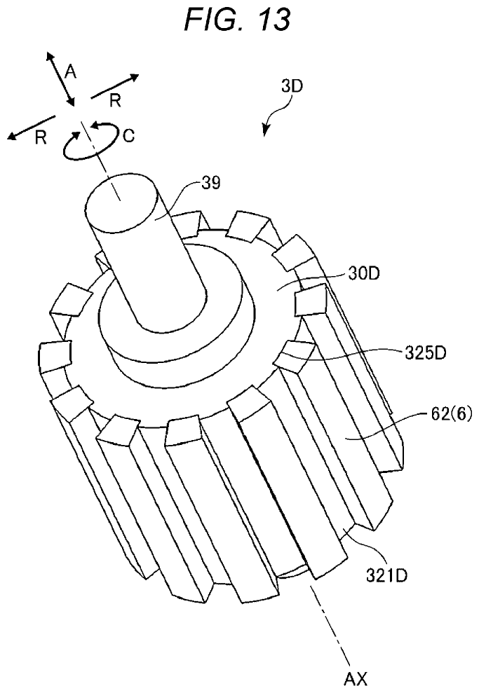

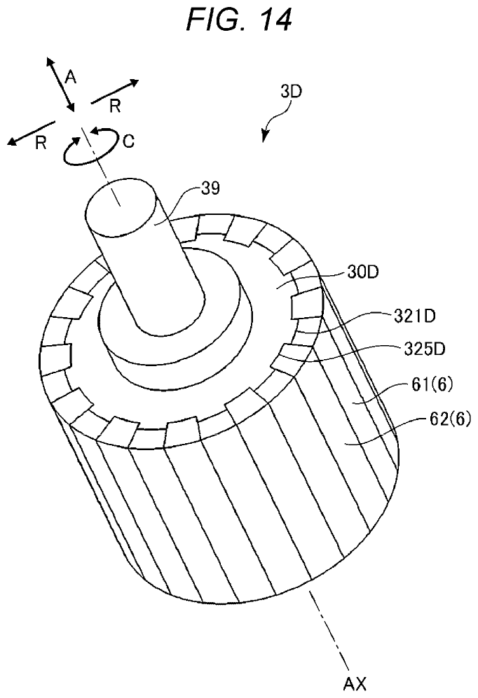

FIG. 12 is a perspective view showing only a shaft 39 and a frame 30D of a rotor 3D included in a radial gap motor, which is the rotary motor according to the third embodiment. FIG. 13 is a perspective view showing a configuration in which the auxiliary pole magnets 62 (the sub-magnets) are added to the frame 30D shown in FIG. 12. FIG. 14 is a perspective view showing a configuration in which the main magnetic pole magnets 61 (the main magnets) are added to the configuration shown in FIG. 13.

The third embodiment is explained below. In the following explanation, differences from the first embodiment are mainly explained. Explanation about similarities to the first embodiment is omitted. In FIGS. 12 to 14, the same components as the components in the first embodiment are denoted by the same reference numerals and signs.

The radial gap motor is a motor in which a gap present between a rotor and a stator is located in the radial direction of the rotor. The rotor 3D shown in FIGS. 12 to 14 is the same as the rotor in the first and second embodiments except that the rotor 3D has a structure for the radial gap motor.

The rotor 3D shown in FIG. 12 includes the shaft 39 and the frame 30D. The shaft 39 is a columnar member extending along the rotation axis AX. The frame 30D is an annular member located on the outer side of the shaft 39 and coupled to the shaft 39.

The shaft 39 is a solid member formed in a columnar shape. The shaft 39 is fixed to the frame 30D by press fitting or the like.

As shown in FIG. 12, the frame 30D includes a first surface 321D, which is a side surface facing the radial direction R, and a plurality of first recesses 325D opened on the first surface 321D.

The first recesses 325D are disposed at equal intervals along the circumferential direction C. The first surface 321D sandwiched by the first recesses 325D is a part further projecting than the first recesses 325D. Accordingly, on the side surface of the frame 30D, the first recesses 325D and the first surface 321D sandwiched by the first recesses 325D are repeatedly disposed side by side along the circumferential direction C.

In FIG. 13, the auxiliary pole magnets 62 are disposed in the first recesses 325D of the frame 30D. By disposing the auxiliary pole magnets 62 in the first recesses 325D in this way, the same effects as the effects in the first embodiment are obtained.

In FIG. 14, The main magnetic pole magnets 61 are disposed among the first recesses 325D of the frame 30D. By disposing the main magnetic pole magnets 61 among the first recesses 325D in this way, the same effects as the effects in the first embodiment are obtained.

By using the frame 30D as explained above, it is possible to easily obtain a Halbach magnet array in which the main magnetic pole magnets 61 and the auxiliary pole magnets 62 are alternately disposed at target pitches along the circumferential direction C.

In the third embodiment explained above, the same effects as the effects in the first embodiment are obtained.

### 6. Fourth Embodiment

A manufacturing method for a rotor according to a fourth embodiment is explained.

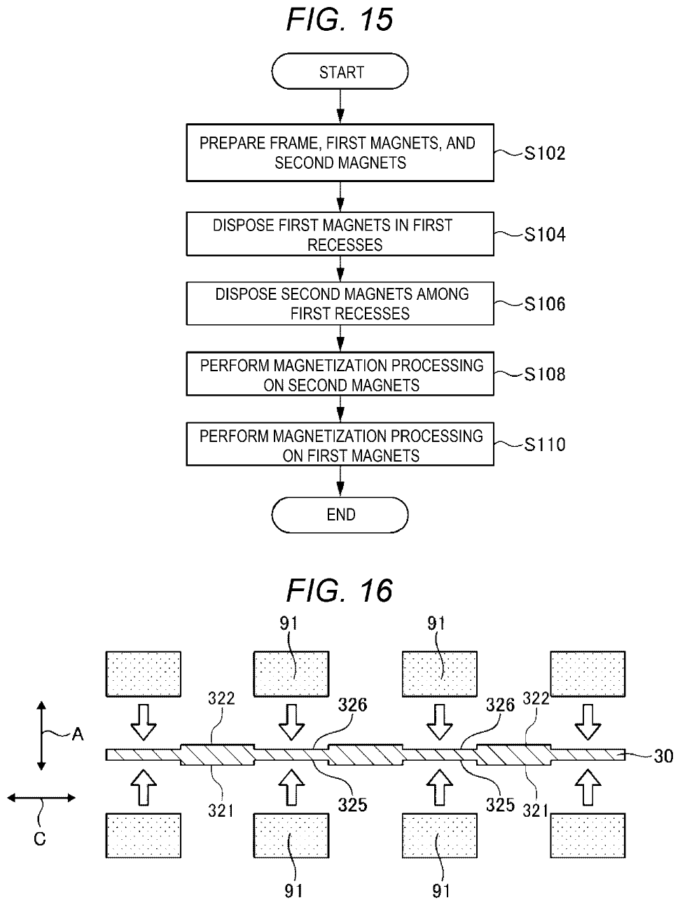

FIG. 15 is a flowchart for explaining the manufacturing method for the rotor according to the fourth embodiment. FIGS. 16 to 18 are sectional views for explaining a manufacturing method for the rotor shown in FIG. 2.

The fourth embodiment is explained below. In the following explanation, differences from the first embodiment are mainly explained. Explanation about similarities to the first embodiment is omitted. In FIGS. 16 to 18, the same components as the components in the first embodiment are denoted by the same reference numerals and signs.

A manufacturing method for the rotor 3 shown in FIG. 15 includes a preparation step S102, a first magnet disposition step S104, a second magnet disposition step S106 a first magnetization step S108, and a second magnetization step S110. The steps are explained below.

In the preparation step S102, as shown in FIG. 16, the frame 30, first magnets 91, and second magnets 92 are prepared. The first magnets 91 can be, through magnetization processing explained below, the permanent magnets 6 disposed in the first recesses 325 and in the second recesses 326 of the frame 30. When the rotor 3 according to the first embodiment is manufactured, the first magnets 91 are the auxiliary pole magnets 62 in an unmagnetized state. The second magnets 92 can be, through the magnetization processing explained below, the permanent magnets 6 disposed among the first recesses 325 and among the second recesses 326 of the frame 30. When the rotor 3 according to the first embodiment is manufactured, the second magnets 92 are the main magnetic pole magnets 61 in the unmagnetized state.

When the rotor 3A according to the second embodiment is manufactured, the first magnets 91 are the main magnetic pole magnets 61A in the unmagnetized state and the second magnets 92 are the auxiliary pole magnets 62 in the unmagnetized state.

In the first magnet disposition step S104, as shown in FIG. 16, the unmagnetized first magnets 91 are respectively disposed in the first recesses 325 and in the second recesses 326. In this disposition work, the positions of the first magnets 91 can be determined by the first recesses 325 and the second recesses 326. Therefore, the disposition work can be efficiently performed. In the unmagnetized state, since a magnetic force hardly occurs in the first magnets 91, the first magnets 91 do not attract one another and the disposition work is easy. Thereafter, the disposed first magnets 91 are fixed in the first recesses 325 and in the second recesses 326.

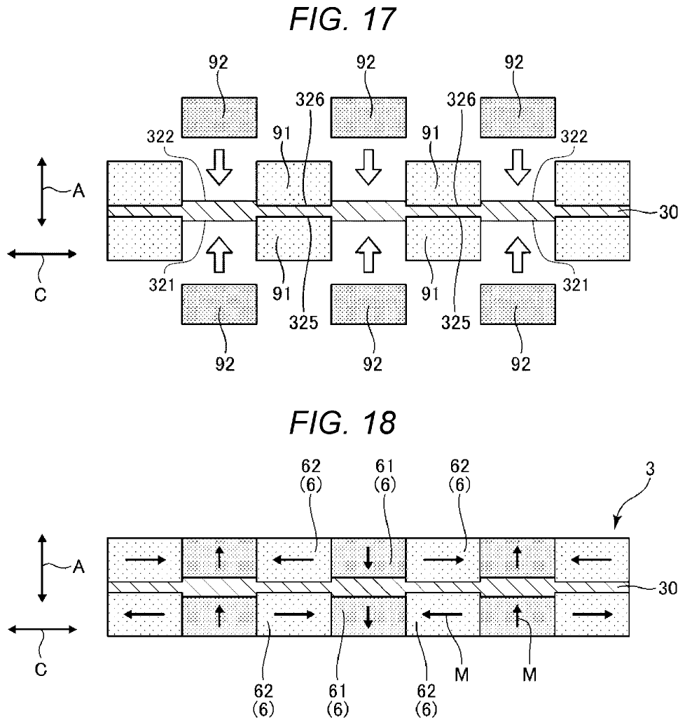

In the second magnet disposition step S106, as shown in FIG. 17, the unmagnetized second magnets 92 are respectively disposed among the first recesses 325 and among the second recesses 326. This disposition work is work for inserting the second magnets 92 into gaps among the first magnets 91. Therefore, the disposition work can be efficiently performed. In the unmagnetized state, since a magnetic force hardly occurs in the second magnets 92, the second magnets 92 do not attract one another and the first magnets 91 and the second magnets 92 do not attract each other. Therefore, the disposition work is easy. Thereafter, the disposed second magnets 92 are fixed among the first recesses 325 and among the second recesses 326.

In the first magnetization step S108, a magnetic field is applied to the second magnets 92 in a longitudinal direction crossing the first surface 321. Consequently, the second magnets 92 are magnetized and, as indicated by arrows M in FIG. 18, the main magnetic pole magnets 61 having magnetic poles in a direction parallel to the axial direction A are obtained.

In the second magnetization step S110, a magnetic field is applied to the first magnets 91 in a lateral direction different from the longitudinal direction. Consequently, the first magnets 91 are magnetized and, as indicated by the arrows M in FIG. 18, the auxiliary pole magnets 62 having magnetic poles in a direction parallel to the circumferential direction C are obtained.

The order of the steps may be changed. For example, the second magnetization step S110 may be provided between the first magnet disposition step S104 and the second magnet disposition step S106. Consequently, when the magnetic field in the lateral direction is applied to the unmagnetized first magnets 91 disposed in the first magnet disposition step S104, interference between a magnetized yoke and the second magnets 92 does not occur. Therefore, it is easy to dispose the magnetized yoke.

In the rotor 3A according to the second embodiment, unlike the fourth embodiment, the unmagnetized first magnets 91 are inserted into the through-holes 34 shown in FIG. 8 and a magnetic field in the vertical direction is applied to the first magnets 91 to magnetize the first magnets 91, whereby the main magnetic pole magnets 61A are obtained. The unmagnetized second magnets 92 are respectively disposed among the first recesses 325 and among the second recesses 326 shown in FIG. 8 and a magnetic field in the lateral direction is applied to the second magnets 92 to magnetize the second magnets 92, whereby the auxiliary pole magnets 62 are obtained. Therefore, when the rotor 3A according to the second embodiment is manufactured, in the first magnetization step S108, the magnetic field in the longitudinal direction only has to be applied to the first magnets 91 and, in the second magnetization step S110, the magnetic field in the lateral direction only has to be applied to the second magnets 92.

As explained above, the manufacturing method for the rotor 3 shown in FIG. 15 includes the preparation step S102, the first magnet disposition step S104, the second magnet disposition step S106, the first magnetization step S108, and the second magnetization step S110. In the preparation step S102, the annular frame 30 including the first surface 321 and the plurality of first recesses 325 arrayed in the circumferential direction C around the rotation axis AX and opened on the first surface 321, the unmagnetized first magnets 91, and the unmagnetized second magnets 92 are prepared. In the first magnet disposition step S104, the first magnets 91 are disposed in the first recesses 325. In the second magnet disposition step S106, the second magnets 92 are disposed among the first recesses 325. In the first magnetization step S108, the magnetic field is applied to one of the first magnets 91 and the second magnets 92 in the longitudinal direction crossing the first surface 321 to magnetize the one of the first magnets 91 and the second magnets 92. In the second magnetization step S110, the magnetic field is applied to the other of the first magnets 91 and the second magnets 92 in the lateral direction crossing the longitudinal direction to magnetize the other of the first magnets 91 and the second magnets 92.

With such a configuration, the magnetization processing is performed after the first magnets 91 and the second magnets 92 are disposed. Therefore, it is possible to efficiently perform the disposition work for the first magnets 91 and the second magnets 92. Since the first recesses 325 are provided in the frame 30, it is possible accurately align the first magnets 91. As a result, it is possible to efficiently manufacture the rotor 3 in which deterioration in a magnetic characteristic involved in positional deviation of the main magnetic pole magnets 61 and the auxiliary pole magnets 62 less easily occurs.

The rotary motor and the manufacturing method for the rotor according to the present disclosure are explained above with reference to the embodiments shown in the figures. However, the present disclosure is not limited to the embodiments.

For example, the rotary motor according to the present disclosure may be a rotary motor in which the sections in the embodiments are replaced with any components having the same functions or may be a rotary motor in which any components are added to the embodiments.

The manufacturing method for the rotor according to the present disclosure may be a manufacturing method in which any target steps are added to the embodiments.

What is claimed is:

1. A rotary motor comprising:
a stator; and
a rotor configured to rotate around a rotation axis, wherein
the rotor includes:
a frame including a first surface facing the stator and a plurality of first recesses arrayed along a circumferential direction around the rotation axis and opened on the first surface, the frame being formed in an annular shape;
main magnets disposed in the first recesses or among the first recesses; and
sub-magnets disposed in the first recesses when the main magnets are disposed among the first recesses and disposed among the first recesses when the main magnets are disposed in the first recesses.

2. The rotary motor according to claim 1, wherein
the frame further includes:
a second surface opposite to the first surface; and
a plurality of second recesses arrayed along the circumferential direction and opened on the second surface, and
positions of the first recesses and positions of the second recesses in the circumferential direction are the same.

3. The rotary motor according to claim 1, wherein the main magnets are disposed among the first recesses and the sub-magnets are disposed in the first recesses.

4. The rotary motor according to claim 3, wherein the sub-magnets include sub-magnet engagement structures that engage in the first recesses.

5. The rotary motor according to claim 2, wherein the frame includes through-holes obtained by connecting the first recesses and the second recesses along the rotation axis.

6. The rotary motor according to claim 5, wherein the main magnets are disposed in the through-holes and the sub-magnets are disposed among the first recesses and among the second recesses.

7. The rotary motor according to claim 6, wherein the main magnets include main magnet engagement structures that engage in the through-holes.

8. The rotary motor according to claim 1, wherein a constituent material of the frame is a nonmagnetic material.

9. The rotary motor according to claim 1, wherein the frame has insulation.

10. A manufacturing method for a rotor comprising:
preparing a frame including a first surface and a plurality of first recesses arrayed in a circumferential direction around the rotation axis and opened on the first surface, the frame being formed in an annular shape, unmagnetized first magnets, and unmagnetized second magnets;
disposing the first magnets in the first recesses;
disposing the second magnets among the first recesses;
applying a magnetic field to one of the first magnets and the second magnets in a longitudinal direction crossing the first surface and magnetizing the one of the first magnets and the second magnets; and
applying a magnetic field to another of the first magnets and the second magnets in a lateral direction different from the longitudinal direction and magnetizing the other of the first magnets and the second magnets.
